(19) United States
(12) Patent Application Publication
(10) Pub. No.: US 2026/0264977 A1
(43) Pub. Date: Sep. 10, 2026

(54) Tarpaulin Container

(71) Applicant: CAKEBOXX TECHNOLOGIES, LLC, McLean, VA (US)

(72) Inventor: Daine Edward Eisold, McLean, VA (US)

(73) Assignee: CAKEBOXX TECHNOLOGIES, LLC, McLean, VA (US)

(21) Appl. No.: 18/875,972

(22) PCT Filed: Jun. 27, 2023
(86) PCT No.: PCT/US2023/026323

§ 371 Date: Dec. 17, 2024

Related U.S. Application Data
(60) Provisional application No. 63/355,812, filed on Jun. 27, 2022.

(51) Int. Cl. B65D 88/58; B23K 9/095

(52) U.S. Cl. CPC B65D 88/58; B23K 9/095

(57) ABSTRACT

Described herein is a tarpaulin container created and fabricated for the secure transportation of compatible cargo. This Convention for Safe Containers (CSC) certified intermodal container is suitable for the transport of cargo that can be cumbersome to load through the doors of an ISO container, and where there may not be height for a removable top. The container includes a rectangular base frame with a length and a width; a floor; a rear end wall assembly; and a front end wall assembly; wherein the base frame, floor, and end wall assemblies are welded together to create the primary structure of the container; and a tarpaulin system that runs the length of the base frame from the front end wall assembly to the rear end wall assembly; wherein there are no permanent connections at the top of the container between the front end wall assembly and the rear end wall assembly.

Described herein is a tarpaulin container created and fabricated for the secure transportation of compatible cargo. This Convention for Safe Containers (CSC) certified intermodal container is suitable for the transport of cargo that can be cumbersome to load through the doors of an ISO container, and where there may not be height for a removable top. All materials used in the construction can withstand extreme temperature ranging from −35° C. (−30° F.) to 77° C. (170° F.) without effect on the container's strength and watertightness.

The unique tarpaulin design of the container described herein is an improvement over traditional-style containers in that it allows easy access to the cargo, without the need to fully remove a lid. The main purpose is to be able to load cargo onto the container from the side, or the top, without the need for a fixed wall. The container can be used to transport any nominal cargos. Further, this design has an additional benefit by offering a use case of vertical storage allowing it to be loaded and unloaded while stacked on top of or beneath other containers.

The CSC certified intermodal container described herein is constructed to be suitable for transportation for the following modes without any permanent deformation, which would render the container unsuitable to use or any abnormality. On the road flat bed or skeletal chassis may be used. The containers may be secured by twistlocks or the equivalent only at the four bottom corner fittings. On flat rail cars, appropriate container cars, or ship, the containers described herein may be secured to rail cars by twistlocks or the equivalent at the four bottom corner fittings of the container or flat car operations.

### BRIEF DESCRIPTION OF THE DRAWINGS

FIG. 1 shows a base with two ends and open sides and top and a tarpaulin cover on sliding supports compacted at the middle of the base for providing access to load or unload heavy objects through the sides with cranes having access from the top.

FIG. 2 shows three heavy sled coils in supports and the tarpaulin covers divided and pushed to the sides.

FIG. 3 shows the container with the tarpaulin covering the whole container.

FIG. 4 is a view from the inside one sidewall of the closed tarpaulin, showing the roof and rear surface formed by the tarpaulin.

FIG. 5 is a perspective view, showing the rear rigid end wall and an inside view with a transparent front wall of the tarpaulin.

FIG. 6 is a side view of the container.

FIG. 7 is a top view of the container.

FIG. 8 is a side view of the container with coils.

FIG. 9 is a side view of the container with coils and a tarpaulin.

FIG. 10 is a side view of the container with two coils.

FIG. 11 is a side view of the container with one coil.

FIG. 12 is a cross section taken along A-A of FIG. 1.

FIG. 13 is an end view of the container.

FIG. 14 is a perspective view of the container.

FIG. 15 is an end view showing storage and tarpaulin locking handle.

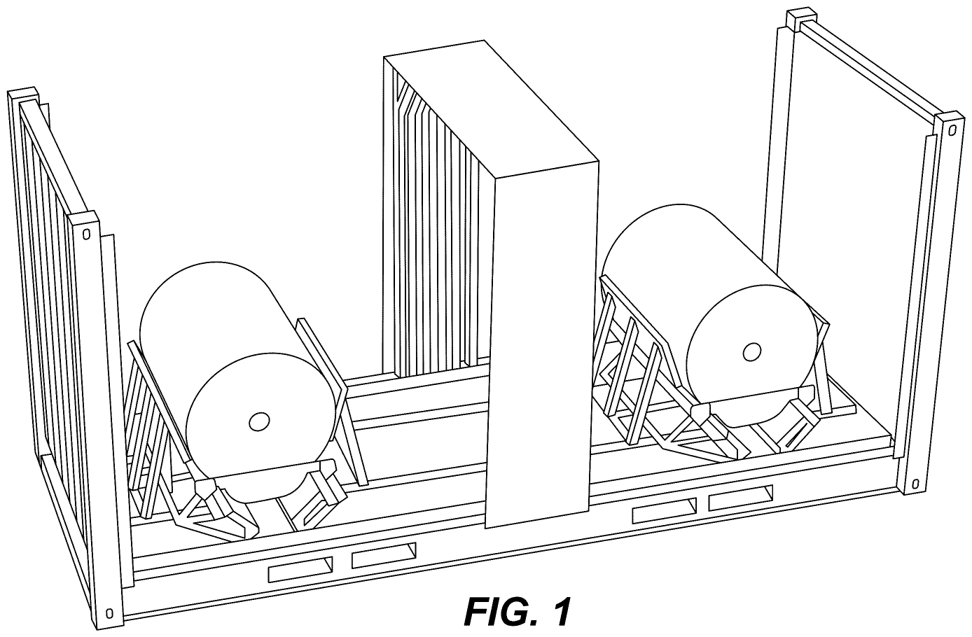

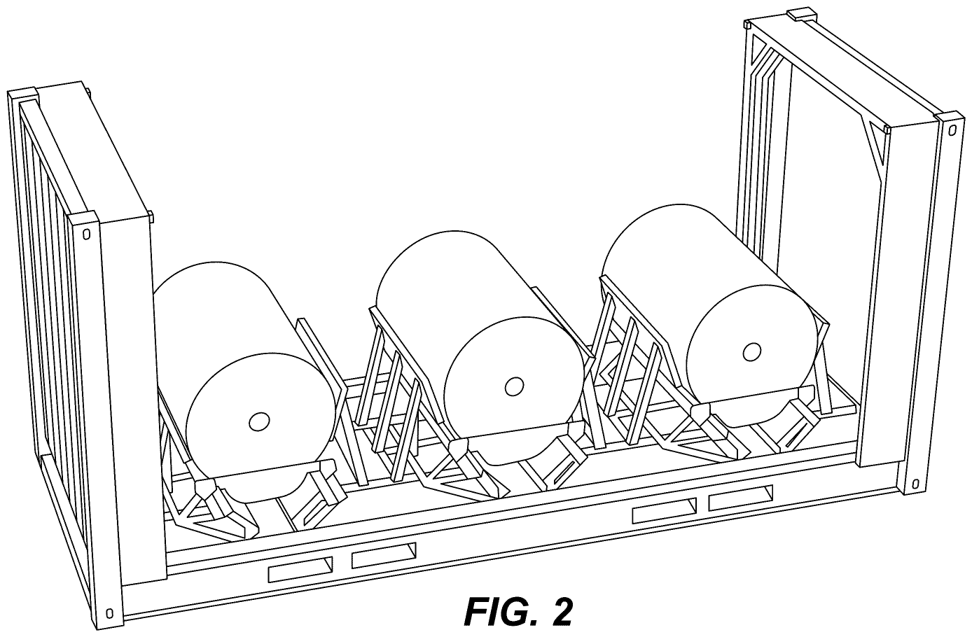

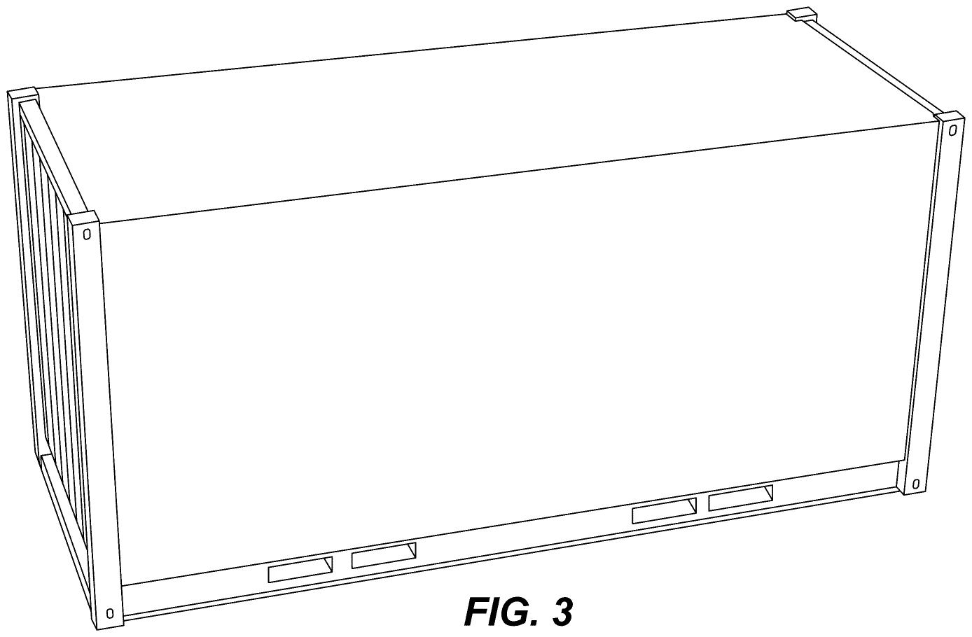

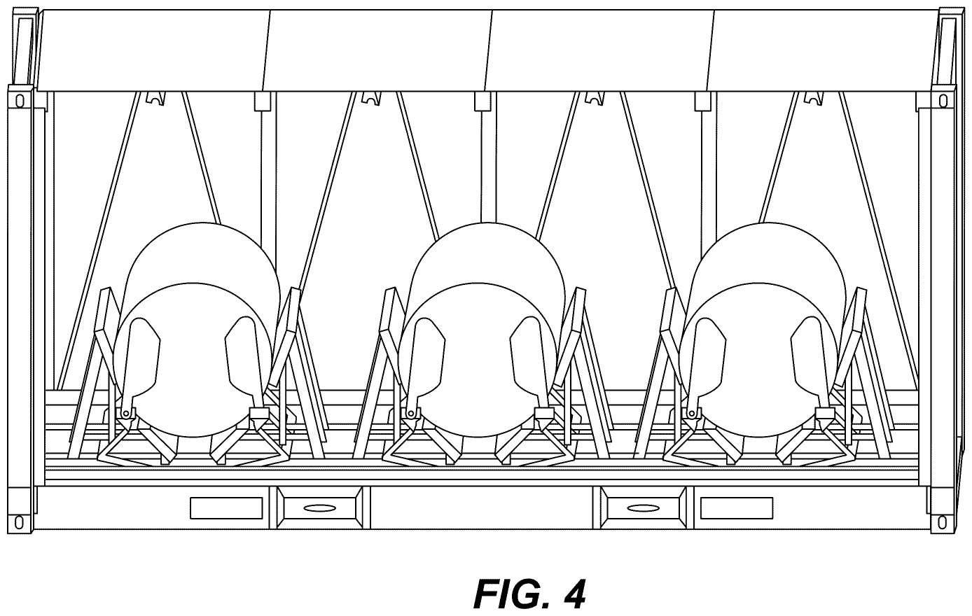

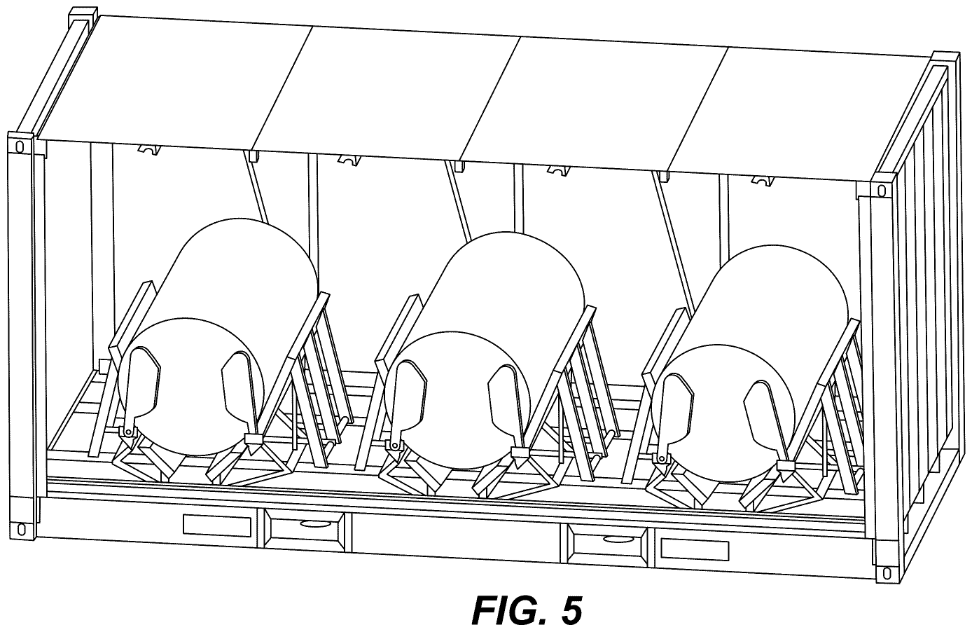

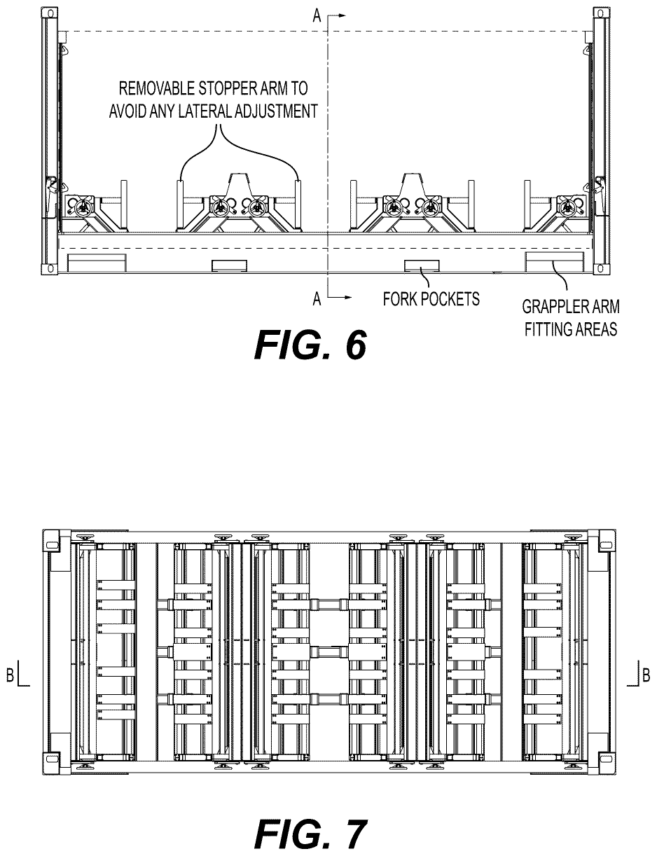

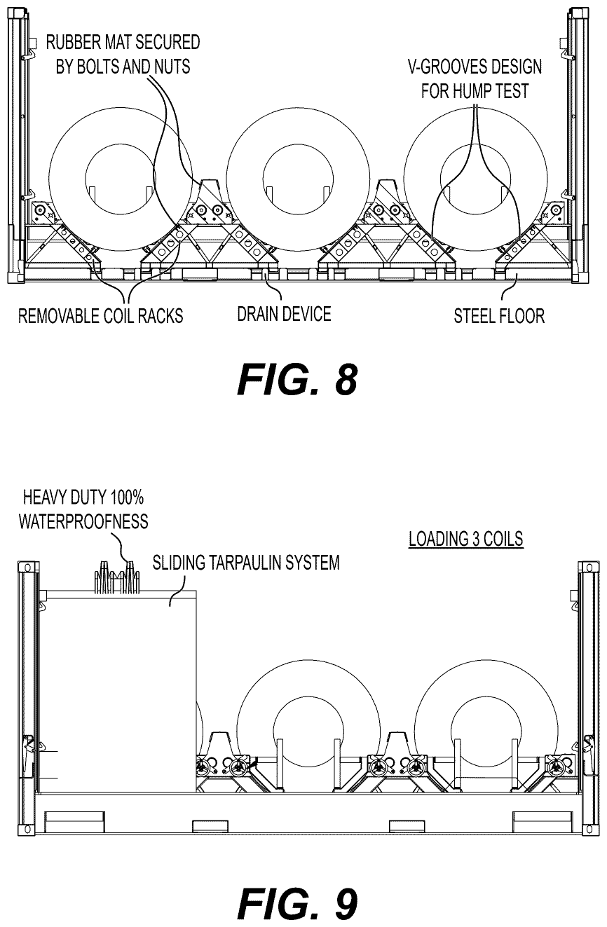

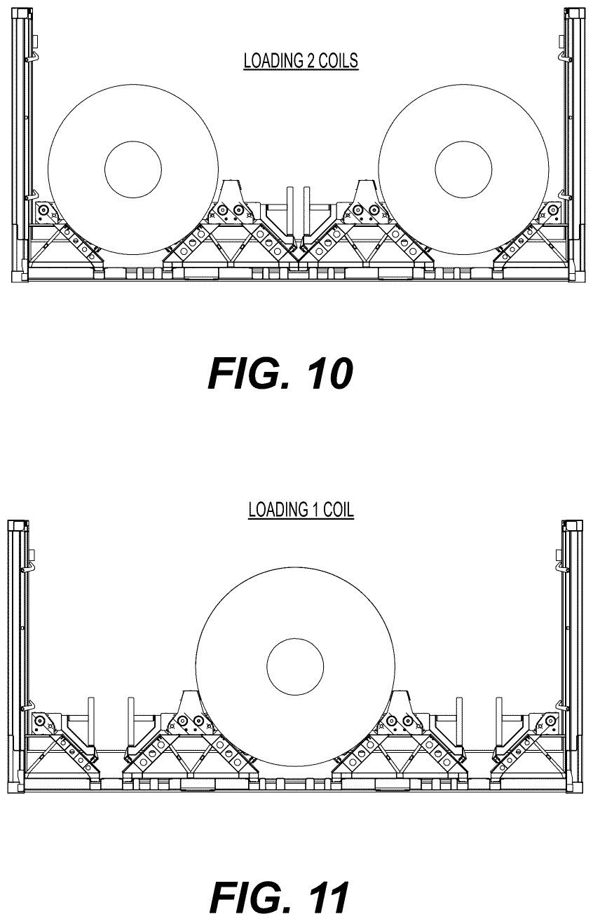

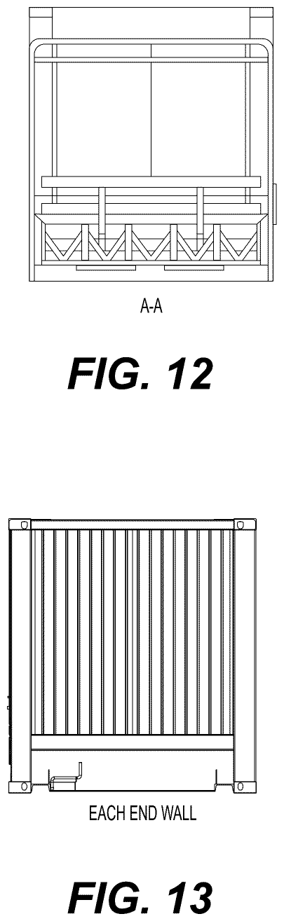

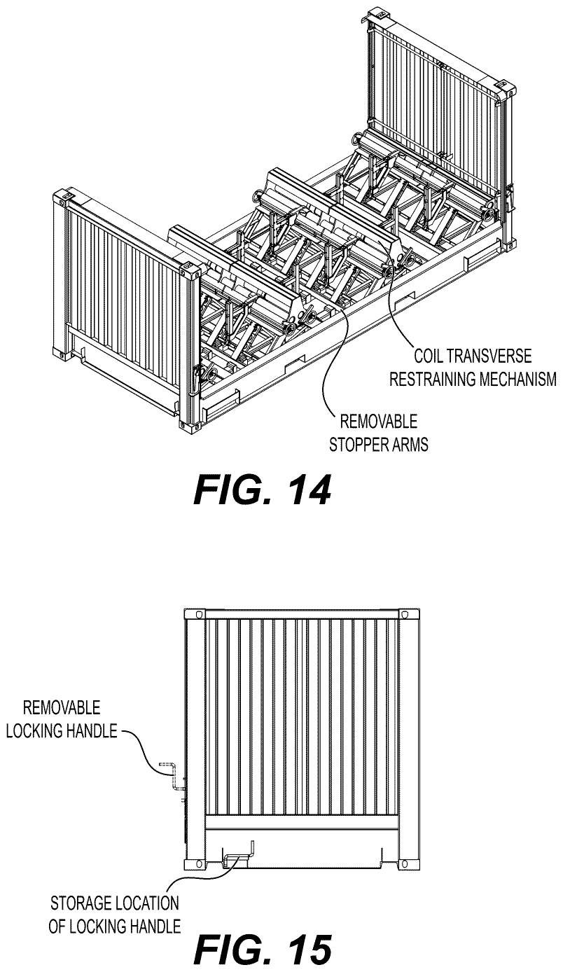

### DETAILED DESCRIPTION

Upon review of the description and embodiments of the present invention, those skilled in the art will understand that modifications and equivalent substitutions may be performed in carrying out the invention without departing from the essence of the invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. Thus, the invention is not meant to be limiting by the embodiments described explicitly above, and is limited only by the claims which follow. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The container described herein may be constructed with steel base frame, steel floor, rear end wall assembly, and front end wall assembly. The base frame and end wall assemblies are welded together to create the primary structure of the container. The cover is a tarpaulin system that runs the length of the container body from end wall to end wall. It is latched at both walls and can be moved to one end or the other for loading and unloading. All steelworks are built up by automatic and semi-automatic CO2 gas arc welding (MAG welding). All exterior welds including that on base structure are continuous to give perfect watertightness. Interior welds are intermittent.

The upper faces of the top corner fittings protrude above the highest level of the container construction, including tarpaulin cover. For the containers under empty condition the lower faces of the cross members in their bases are above the lower faces of the bottom corner fittings. For containers under the load equal to 1.8R-T is uniformly distributed over the floor, no part of the container base deflects below the lower faces of the bottom corner fitting plates. Corner fittings are in accordance with ISO/1161 standard and are supplied by classification society approved manufacturer.

### Main Container Assembly

The main container assembly consists of four corner fittings at the bottom of the container, connected together with two side rails and two end rails. There are also a number of crossmembers and a pair of fork pockets built into the container base. A floor is fitted inside the base with channels running along the length of the container for securing cargo and support structures. The floor is constructed with thick smooth steel plates which are butt welded and continuously welded to base end rails and base side rails inside, and are stitch welded to crossmembers. Each bottom side rail is an “I” beam channel running the length of the base. There are two fork pockets located along the length of the members and the crossmembers connect the side rails across the width of the base. The crossmembers are composed of a number of pressed channel sections, which are placed at certain center distances. Each fork tube pocket is composed of a steel pressing made in one piece in according with ISO requirements for handling. Each base end rail is a steel pressing made in one piece.

Each end frame has two corner posts, one header, rear panels, four corner fittings, and a specialized tarpaulin lock. Each corner post has an inner part and an outer part, welded together as one part. The header has an end top rail of pressed channel section and an upper plate, welded together as a part. Each wall is a steel sheet fully vertically corrugated into trapezium sections, butt joint together to form one panel by means of automatic MAG welding. There are no permanent connections at the top of the container between the opposing end walls.

All the overlapped joints and all the places where water may leak are sealed to prevent water entry and cargo containment. Sealant Materials are waterborne/chloroprene in cargo contact area and Butyl in hidden parts.

### Tarpaulin Cover

The tarpaulin cover is designed to expand across the entire length of the open section. The assembly consists of a number of main support members, small support members, cables, support beams, rollers, brushes, and the tarp cover.

The tarpaulin cover is supported underneath by upside down “U” shaped members across the width of the container. The tarp connects to the support members at various connection points along the length of the members. There is a rail at the bottom of the tarpaulin system that works to support the rollers and guide the tarp system along the container length. The rollers are placed at intermittent points along the length of the tarpaulin system to aid in the use of the systems. There are small brushes located along the rail of the tarp system to prevent dust and debris from damaging the rail and wheels. The tarp is connected to the frame by a band that runs through connection loops on the inside of the tarp to the main frame of the system. Each end of the tarp system has a reinforced frame that acts to connect the system to the frame of the container, while supplying additional stability to the system. The tarp system can be operated from either side via the locks located through the end walls of the container. The roof of the tarp system is bowed to prevent water from pooling on top. This design has an additional benefit by offering a use case of vertical storage allowing it to be loaded and unloaded while stacked.

What is claimed is

1. A container comprising
a rectangular base frame with a length and a width;
a floor;
a rear end wall assembly; and
a front end wall assembly;
wherein the base frame, floor, and end wall assemblies are welded together to create the primary structure of the container; and
a tarpaulin system that runs the length of the base frame from the front end wall assembly to the rear end wall assembly;
wherein there are no permanent connections at the top of the container between the front end wall assembly and the rear end wall assembly.

2. The container of claim 1, wherein the tarpaulin system is removably latched at both end wall assemblies, and can be moved to from end to end to permit loading and unloading of the container.

3. The container of claim 1, wherein the container is fabricated from steel, built up by automatic and semi-automatic CO₂ gas arc welding (MAG welding).

4. The container of claim 3, wherein all exterior welds, including those on the base, are continuous to give perfect watertightness.

5. The container of claim 3, wherein interior welds are intermittent.

6. The container of claim 1, wherein the base frame comprises two side rails, two end rails, and four corner fittings.

7. The container of claim 6, further comprising crossmembers and one or more pairs of fork pockets built into the container base.

8. The container of claim 1, wherein the floor is fitted inside the base frame, with channels running along the length of the container for securing cargo and support structures.

9. The container of claim 7, wherein the floor is constructed with thick smooth steel plates which are butt welded and continuously welded to base end rails and base side rails inside, and are stitch welded to crossmembers.

10. The container of claim 7, wherein each side rail is an “I” beam channel running the length of the base.

11. The container of claim 7, wherein the crossmembers connect the side rails across the width of the base.

12. The container of claim 7, wherein the crossmembers comprise pressed channel sections.

13. The container of claim 7, wherein each fork tube pocket is composed of a steel pressing made in one piece.

14. The container of claim 7, wherein each base end rail is a steel pressing made in one piece.

15. The container of claim 1, wherein each end wall assembly comprises a wall, two corner posts, one header, rear panels, four corner fittings, and a specialized tarpaulin lock.

16. The container of claim 15, wherein each corner post comprises an inner part and an outer part, welded together as one part.

17. The container of claim 15, wherein each header comprises an end top rail of pressed channel section and an upper plate, welded together as a part.

18. The container of claim 15, wherein each wall comprises a steel sheet fully vertically corrugated into trapezium sections, butt joint together to form one panel by means of automatic MAG welding.

19. The container of claim 1, wherein all overlapped joints and all places where water may leak are sealed with at least one sealant material to prevent water entry and to ensure cargo containment.

20. The container of claim 19, wherein sealant materials are waterborne/chloroprene in cargo contact areas and butyl in hidden parts.

21. The container of claim 1, wherein the tarpaulin assembly comprises a rectangular tarpaulin cover that is configured to expand across the entire length of the container, such that when the tarpaulin cover is fully expanded, it covers the entire container.

22. The container of claim 21, wherein the tarpaulin cover is supported underneath by one or more upside down “U” shaped support members across the width of the container.

23. The container of claim 22, wherein the tarpaulin cover connects to the support members at various connection points along the length of the support members.

24. The container of claim 21, wherein the tarpaulin assembly further comprises a rail at the bottom of the tarpaulin system and one or more rollers disposed at intermittent points along the length of the tarpaulin assembly, wherein the rail is configured to support the rollers and guide the tarpaulin cover along the container length.

25. The container of claim 24, wherein the tarpaulin assembly further comprises brushes located along the rail to prevent dust and debris from damaging the rail and wheels.

26. The container of claim 21, wherein the tarpaulin cover is connected to the end wall assemblies by a band that runs through connection loops on the inside of the tarpaulin cover.

27. The container of claim 21, wherein each end of the tarpaulin cover is supported by a reinforced frame that acts to connect the tarpaulin assembly to the container, while supplying additional stability to the tarpaulin assembly.

28. The container of claim 1, wherein the tarpaulin assembly is configured to be operated from either side via locks located through the end walls of the container.

29. The container of claim 1, wherein the tarpaulin assembly is configured such that when the tarpaulin cover is fully expanded, it forms a roof on the container which is bowed to prevent water from pooling on top.
